(19) United States
(12) Patent Application Publication
(10) Pub. No.: US 2007/0069973 A1
(43) Pub. Date: Mar. 29, 2007

(54) Controlled and Monitored Remote Advertising and Information Display System

(76) Inventors: WILLIAM EDWARD GERBACIA, TINTON FALLS, NJ (US); BRYAN EDWARD GERBACIA, TINTON FALLS, NJ (US)

Correspondence Address: WILLIAM GERBACIA, 37 ALDEN LANE, TINTON FALLS, NJ, 07724, US

(21) Appl. No.: 11/308,811

(22) Filed: May 10, 2006

Related U.S. Application Data
(60) Provisional application No. 60/594,837, filed on May 10, 2005.

(51) Int. Cl. G09G 5/00

(52) U.S. Cl. 345/1.1

(57) ABSTRACT

A network of modular video display stations controlled from one or more remote locations using commercially available or proprietary software. Each station contains a complete modular computer system and one or more display screens which can be arranged in many configurations. Each station is equipped with one or more cameras to provide visual data to the control centers. The content of the stations can be changed randomly and directed for viewing over a public network such as the internet. Data is transmitted to and from the stations via wireless or wired commercial or proprietary networks. Displayed information can be presented with or without sound, and the volume can be controlled from a central location. Stations can be fitted with various other devices, such as printers or microphones, and can contain dispensers for preprinted information.

### FIELD OF THE INVENTION

The present invention relates to a system for displaying information to the public via computer controlled and monitored displays.

### BACKGROUND OF THE INVENTION

Advertising and the provision of information are major industries. Advertisers in particular are frequently searching for new was to locate potential customers and communicate with existing customers. Outdoor or away-from-home advertising has, until recently, been limited to static signs, or light sequenced signs of limited capability. Recent video signs have are bulky and expensive and provide no ability to view, and, therefore, sample the audience viewing the display. It would be advantageous to advertisers to provide a system with these characteristics, such as the current invention.

### SUMMARY AND OBJECTS OF THE INVENTION

It is one of the primary objectives of the present invention to provide an electronic display sign which can display color full motion video, animated graphics, or static displays with or without accompanying audio, on a display which can be monitored from a central location, and which can be deployed in many different configurations.

It is another objective of this invention to provide a means of changing the sequence of information displayed on the screen or to change the informational content of the display from a central location over a wired or wireless network.

It is a further objective of this invention to provide a means of viewing the content of the display screen in real-time and the status and operation of the display sign in general from a remote location.

It is another objective of this invention to provide a means of viewing the audience of a display sign from the perspective of the display sign, in real-time.

It is yet another objective of this invention to provide a means for estimating basic demographic data and numbers of viewers in front of a display screen at any time.

It is still another objective of the present invention to provide a display sign that is easily configurable such that one sign can be used or a multitude of signs can be used in different arrangements to allow viewers to view the same display from multiple directions, or different displays from multiple directions or a single direction.

It is yet another objective of the present invention to provide a means of arranging a series of small displays such that the display on each small screen forms part of a much larger display which would be the equivalent of a full-motion video billboard, which can be controlled, changed and monitored from a central location.

It is an additional objective of this invention to provide a display means embedded in a table, such that the display is visible through the table's transparent table top.

It is a further objective of this invention to provide a display sign that can be equipped with ancillary devices to allow interaction with viewers to gather information or provide order entry, or deliver printed information to the viewer at the remote location.

Additionally, it is another objective of this invention to provide a display sign with a motion sensor that raises the volume of the audio output associated with the visual display when an individual passes in close proximity to the device.

It is yet another object of this invention to provide a modular system and mounting means to increase the efficiencies of assembly and maintenance.

This invention relates to the general class of advertising and informational displays. The most prevalent system is a static printed display on a substrate, and more recent electronic displays only allow the interchange of static displays or minimal animation of the display, changing displays via, for example, closed circuit TV, or up dates via e-mail over the internet, the display system of this invention provides full-motion video displays in a format similar to current display signs that are updatable over a wireless or wired proprietary network in a multitude of physical configurations, allows visual observation of viewers, allows direct observation of the function of all display station, allows for control and monitoring from a multitude of control centers which may be within or outside of the display stations′ WAN, allows for the display stations to be mobile or statically located, provides the facilities to allow clients to view their information at their own locations, provides the facilities to display the information that is showing on any display station and the viewers in front of the display station on client computers located anywhere that the internet is accessible, and to other viewers outside of the networks, and is constructed in a modular fashion to facilitate rapid and easy assembly of the display stations. The display sign of the current invention also allows for the display of full-motion video displays with or without audio content the volume of the audio can be controlled from any of the control centers, the audio stream can be turned on or off from the control station, and the invention provides a means of sensing motion near the devices such that the volume of the audio stream can be raised when viewers are present. The invention also provides a means for a viewer of the display station to receive printed information regarding one or all of the information segments that are displayed on the display stations.

The display station consists essentially of a computer attached to a flat panel screen. The computer is tuned specifically for full-motion video display, which also permits the display of static images and animations at high resolution. Attached to and part of the computer system is a volatile storage device, such as, but not limited to a hard disk drive. Also, part of the computer system is a network interface which can be on the mother board or added as a circuit board connected to the computer via a socket. The network interface can be attached to a wired or wireless network. Also, inherent to the computer system is an audio process circuit which allows audio content to be played by the system. The display unit contains a power supply to convert line current and voltage to that required by the internal computer. The whole assembly is enclosed in a relatively thin compartment with the flat panel screen visible to any viewers. Included In the assembly is a set of small speakers connected to the audio output of the computer, and a ventilation system to maintain proper temperature in the enclosure. In one embodiment of the invention, a small video camera is included in the enclosure attached to the computer's video input circuit. Other embodiments contain a thermal printer which allows printing of information such as contact information regarding any of the displays that are shown on the display station. Another embodiment provides an internal compartment containing preprinted information on cards or paper strips containing contact information regarding all displays shown on the display station. Another embodiment provides for the mounting of the display station on a mobile truck or other vehicle so as to provide a mobile “billboard” to move the display, for example, through a high traffic area of major metropolitan centers. The display can be mounted at any angle from ninety degrees to forty-five degrees relative to the back edge of the truck, or the front edge of the truck bed. Mounting the screens at an angle to the back edge of the truck bed allows for easier viewing by viewers behind and to the side of the vehicle. Mounting the screens at an angle to the front edge of the truck bed allows for easier viewing by viewers in front and to the side of the vehicle. In either case, aerodynamic shields are provided on top and on the edges of the screens toward the front of the vehicle.

The whole enclosure is insulated and contains a mechanism to cool the internal circuits to prevent overheating. The ventilation mechanism is designed for the type of location—indoor or outdoor. In either case the openings for the ventilation system are protected from sources of intrusion. The operation of the cooling system can be monitored and controlled remotely. The display screen is covered with a transparent rigid protective sheet of material, such as but not limited to, Plexiglas™.

Information, as electronic data, is entered into the display system and updated most frequently via the network interface circuit. Data can also be entered through the onboard ports such as serial or USB ports from an external storage device such as a CD ROM drive, memory stick or other similar external storage device. The data is stored in the internal storage device as a data file for display at the appropriate time. Data files are entered into a play list that is used by the software to sequence the files, such that the first file is played first, then the second, etc. The sequence is repeated when the last file in the list is reached.

Any file can be changed at any time. It is only required that a new file with the same name be substituted in the play list. Files can be transferred by control personnel who monitor the operation of the display device from a control center. New files can also be added to the play list. In this way, the control personnel have complete control over what is displayed on the screen of the display device. The control personnel can also change the order of the files in the play list if required. The system also provides a means by which the control personal can change the manner in which the data is displayed on the display screen of the device. For example, the color or brightness of the display can be changed remotely. In this way, the system of this invention allows complete flexibility in how the files are displayed.

The system of this invention provides the ability for the control personnel to monitor what is on the display screen of each of the display devices. A computer program recreates the display on the display device on the screen monitored by the control personnel at the remote control center. An additional program allows the control personnel to monitor the status and functions of the remote display device's internal computer, storage device, network interface and audio circuit. In this way the display stations can be controlled and monitored remotely. This cuts down on the cost of maintaining the system. Routine maintenance can be done by the control personnel remotely, and costly visits to the display stations can be minimized and focus only on malfunctions that cannot be remedied remotely.

An additional benefit of this invention is that clients who display advertisements or other information on the display device can view the display in real-time. They can then request changes and the control personnel can make the changes directly to the display without physically going to the display device.

Some locations may not be suitable for playing the audio component of a display. In these cases this invention provides a process for replacing the audio component of an advertisement, for example, with text in the video stream. The text can be a direct transcription of the audio portion or a shorter version capturing the highlights of the original audio message and displayed, for example, as “closed captions” beneath, above, next to or directly overlaid on the video component.

The present invention also provides a means for monitoring the audience in front of any display station at any time. A small video camera is located inside the display station. An orifice in the housing allows the camera to capture real-time video of anyone in front of the device. This information is transmitted over the network to the control center. There it can be stored on a suitable storage device for later analysis, and it can also be viewed as it is obtained. The audience can be analyzed visually by the control personnel, the clients monitoring the station, or by suitable recognition software. This function allows for more precise estimation of the types of audiences viewing the display. The display can then be changed, if required, to suit the audience viewing at the time.

The current state of out-of-home advertising does not readily allow the capture of information regarding viewing audience. This kind of information is rather costly to obtain. With the system of the present invention, audience viewing information is part of the routine data gathering capabilities of the device.

This real-time video capture also provides a security feature. Anyone tampering with the device will be captured on video. This may aide in capturing any perpetrator and, more importantly, may act as a deterrent to many malefactors.

The display units can be configured in numerous ways. The most common would be for the display unit to have the aspect of rectangular sign but somewhat thicker. However, the housing can be of any shape, as long as it is large enough to contain the internal computer. The display screen will most commonly be rectangular, but other shapes can be constructed and used.

Multiple independent display units or single display master units with multiple display screens can be arranged in a plurality of configurations. As one example, one display unit can have two display screens, one screen on one side and another on the opposite side. The unit could be mounted on a pedestal stand or suspended from a ceiling or other overhanging structure. In this way, viewers approaching from two different directions can see the display. The display screens could each display the same video stream or different video streams can be displayed on each screen. Both screens are controlled by the same internal computer. This configuration decreases the cost per display screen. Many other configurations are described.

Full-motion video can be interlaced with animated graphics images or static displays. The content of the entire display stream is downloaded as separate files to the display units. The downloaded files are assembled into a play list in the storage device of the display unit. The control program on the display unit can then run the files as they are sequenced in the play list. New files can be inserted and others withdrawn at any time by the control personnel at the remote location. In this way, the sequence of the displays and the content can be controlled. All information is encrypted for downloading. The entire network of display units is protected by a firewall and other security devices to prevent unauthorized tampering.

The objectives and benefits of this invention have been met by this invention which has been described briefly. A more detailed description follows. However, it should be known that the description that is contained here is set forth for purposes of illustrations of the general purposes and benefits of the invention and in no way limit the scope of the invention.

### BRIEF DESCRIPTION OF THE DRAWINGS

The invention has been described in general terms. However, it is best understood from the detailed discussion in the next section which should be read in conjunction with the accompanying figures. The figures include the following:

FIG. 1 is a flow diagram of the process used to prepare information for display.

FIG. 2 is a flow diagram of the process used to load information onto the remote display stations for display to viewers.

FIG. 3 is a schematic showing the configuration of components in a wireless network which links the control and monitoring center to the remote display stations that are within range of the wide area network.

FIG. 4 is a schematic showing the configuration of components in a wireless network linked to a very remote control and monitoring center using the facilities of the internet to link the WAN to the control and monitoring center.

FIG. 5 shows a schematic of two configurations of base module layouts for the a display station control computer module.

FIG. 6 is a schematic of the mounting frames used in fixing the computer module alone, or the computer module and the display screen within the external display station housing.

FIG. 7 is a schematic of a mounting bracket that is used to fix a display screen to the mounting frame shown in FIG. 6.

FIG. 8 is a cross-section showing the relative arrangements of the major components within the external housing of the display station.

FIG. 9 is a schematic showing the method of retaining and protecting the front of the display screen within the external housing (FIG. 9A) and an alternative means of fixing a display screen within the external housing (FIG. 9B), and a cross-section of these components (FIG. 9C).

FIG. 10 is a representation showing a non-exhaustive sample of the numerous configurations of display stations.

FIG. 11 shows a schematic of the baffles used for a display station exposed to an external environment used to prevent moisture from entering the display station

### DETAILED DESCRIPTION OF A PREFERRED EMBODIMENT

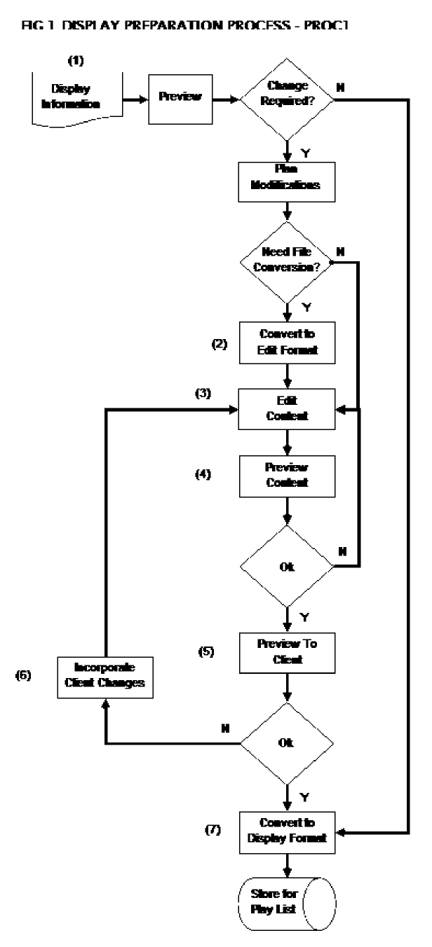

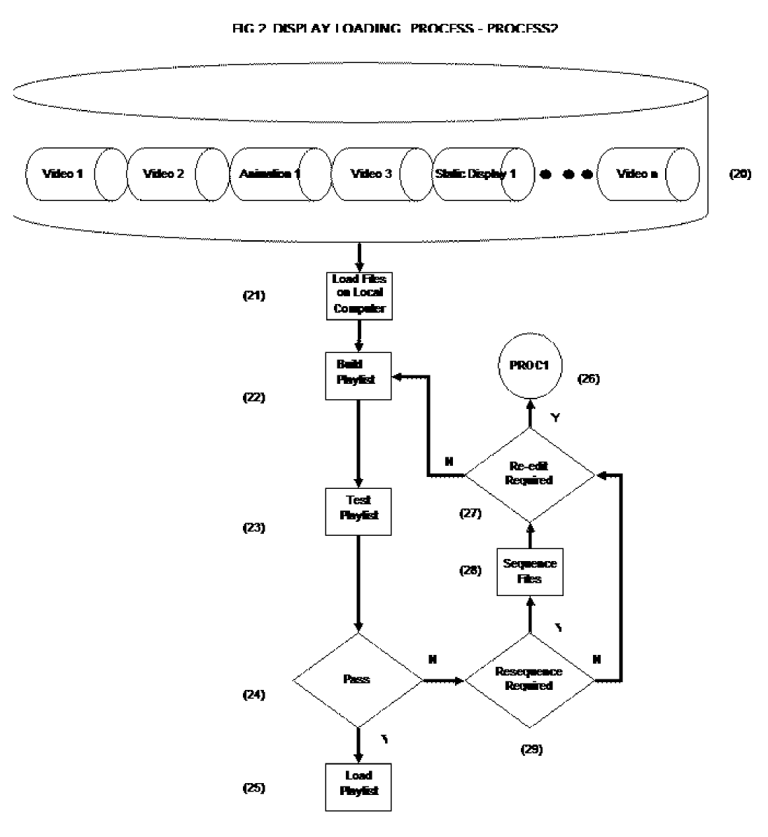

The advertising and information display system of this invention includes the configurations of hardware and software and the processes used to bring these together to provide a variety of display types, including full-motion video, and interactive control and monitoring. FIG. 1 illustrates the process used to put the information that will eventually be displayed on the network of display stations in the format required for display. This is the first part of the total process required to assemble the complete stream of information for downloading to the display stations.

For example, if a series of ten advertisements were to be displayed on the stations, and these advertisements came from ten clients, the display data would probably be in different formats. Some might be avi video, some might be standard VHS video tape, some might be mpeg on a CD, some might be in a slide show format, and still others might be hard copies of static graphic or photographic displays. Each of these would be submitted individually to the process shown in FIG. 1 to convert them all to a format suitable to be displayed together as a single display stream. Another process described later would place the data on the appropriate display station for presentation.

Referring now in more detail and by reference to the characters in FIG. 1, at (1) displays of any type can be presented to the process at (1). The information could be a static image on paper, or some other medium, or a file of static display information in any graphics file format, such as, but not limited to, gif, jpeg, bmp, jpg, pic, pcd, pct, fpx, cdr, ps, tif, pcx, etc. The information could be an animated sign with text or drawn graphics that move around and across the screen. This kind of information could be an animated jpeg or ppt file as two specific, but not limiting, format types. However, any format of animated graphics is acceptable. The information could also be a full-motion video file on a DVD, CD, tape, disk or any other digital or analog data storage medium. The formats of the data on the storage medium could be mpeg, mpg, avi, DivX, or any other currently available data format. Each of these data entities is processed separately using the process described in FIG. 1.

The information at (1) enters the process. It is first previewed to determine whether any changes are required to adapt it to the display station format, and to categorize it for suitability in a given location. If it is determined that no content changes are required, it is ready for format conversion at (7).

If modifications to the content are required, the modifications are planned and, if necessary, communicated to the client. The data is converted to a format suitable for editing (2) and the modifications to the content are made at (3). The results are reviewed again (4) and if necessary reprocessed at (3). When acceptable, the results are reviewed with the client (5). Any additional required changes are put through the process again (6).

Process steps at (2), (3) and (7) require specific software solutions which are a part of this embodiment. Several different software applications can provide the functionality required by these steps. The following is a description of some specific software applications that can be used to satisfy the functionality required at steps (2), (3) and (7). These are one example of the preferred embodiment, but should not be construed as limiting the scope of the invention.

At step (2) the received data whether it is in an electronic file format or a “hard copy” display, such as a sign, must be converted to a format which is usable in the edit step (3). For electronic data files a program such as AVS Video Converter™, Easy Video Converter™, or OSS Video Converter™ are used to convert video files of any format into .avi, .mov or .mpeg format. The converted file, for example an avi formated file, is then used in a program such as Premiere™ to edit the video content. Editing might take the form of adding text layers over the video content to provide textual content that can further enhance the display to better convey the message to the viewers, or to provide a visual synopsis of the voiced content of the display for use in areas in which using audio is either not permitted or is impractical due to, for example, the ambient noise level of the location.

Static displays received on “hard-copy” media, such as paper of fiber board, are converted to digital data by scanning or digital photography. The digital data is then submitted to the process as a jpeg, bmp or gif file. The image can then be edited as described in the following paragraphs.

Editing at step (3) can also take the form of adding special effects to a video image. Special effects can consist, for example, of adding transitions fades and dissolves to move smoothly from one scene to another. Special effects can also consists of adding animated images into existing video sequences, or adding ripple effects to speeding vehicles and the like. In addition, images can be cut-out and new images added to scenes or new backgrounds can be added. All of these are added at step 3 to enhance the visual character of the display to gather more attention. Several software applications can be used to accomplish this editing. Premier™, After Effects™, and Flash MX 2004™ are several of the applications that can accomplish this task. Premier™ and After Effects™ are used in the preferred embodiment when using a MS Windows™ based system and Final Cut™ and After Effects™ are used in the preferred embodiment when using a Macintosh™ based system.

Editing of static displays can consist of, but is not limited to, adding or changing backgrounds or highlighting or cropping certain areas of the image, and changing or adding text. An audio stream can be added to enhance the attractiveness and heighten awareness of the display. All of these techniques are performed on the digital data of the display. Fades can then be incorporated to transit smoothly from one display to the next.

Editing of animated graphic displays consists of, but is not limited to, techniques of adding additional layers of animation which contain additional characters or text. Existing layers of animation can be cropped or certain areas can be highlighted, image and color quality improved, audio added, removed or changed, and fades added. These layers of animation can be edited with any of a number of software applications such as, but not limited to, Fireworks™, Premier™, and Photoshop™.

The display resulting from editing step (3) is reviewed at all required levels, (4) and (5), and any changes are planned (6) and incorporated by redoing the editing step (3). This cycle is repeated until the desired result is achieved.

Once these steps have been completed the final display is converted to a common format (7) for eventual deployment to the display stations. In the preferred embodiment, the digital data is converted to mpeg-4 format. This is by no means the only viable format, and should not be considered limiting to the scope of the present invention. Each set of display data, a data file, is converted to this format to provide consistency, ease of use, and to minimize training requirements for monitoring and maintenance personnel which would be increased if multiple formats were used. It also decreases software maintenance and licensing fees below what would be required to employ a multiplicity of applications to accomplish the same task. By way of example of additional applications that could be used, we mention Maya™, Lightwave™ and proprietary software, any of which could be used to accomplish the same task.

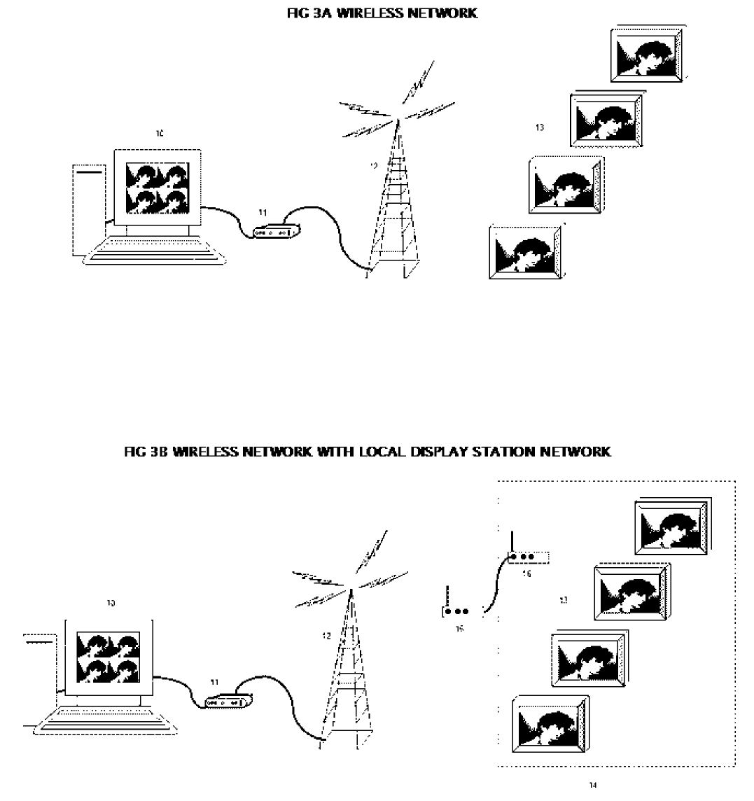

Using a unified format allows the use of only one software application to render the data on the display devices. The formatted display data files are then loaded onto a storage device (7) until assembly in a play list, testing and deployment in the next process, FIG. 2.

As the process depicted in FIG. 2 shows, the display files are loaded onto a local computer, if they are not already stored there, for further processing. The files are then loaded into the player program and put in the required sequence to build the play list. The play list is then tested by running it on the local computer to check that it runs correctly, check color balance, volume level, etc. If the files require only re-sequencing the play list is built again and the test is re-run. If one or more of the files requires additional editing, the files are put through the process shown in FIG. 1 again, and then brought back into the play list build process.

Once the information is prepared and tested it is ready for distribution and display on the remote display stations. This can be accomplished in a number of ways depending upon the physical connection between the computer in the control center and the remote display station. The connection could be via a network cable such as a Category 5 cable, coax cable via a commercial cable network, through a modem over a telephone line, or as in the preferred embodiment, via a wireless network, FIG. 3A. The wireless network can be a private or public commercial network. In such an arrangement the control center computer (10) can monitor a multiplicity of display stations (13). The connection from the control center (10) computer to the display stations (13) is made via an appropriate cable modem or router (11), depending upon the network type to the network broadcast means (12). The data is then transmitted directly to the display stations. The control computer and the display stations constitute a wide area network (WAN).

In some cases it may be necessary to establish an access point (AP) in which the wireless network is connected to a local area network (LAN) which is wireless or wired, FIG. 3B. This solution is required in cases in which the wireless signal cannot reach inside a structure (14). The AP (15) would be placed outside the structure, for example on the roof. The AP (15) would be connected to a wired router or a wireless router (16) which provides the connection to the multiplicity of display stations (13) inside the structure.

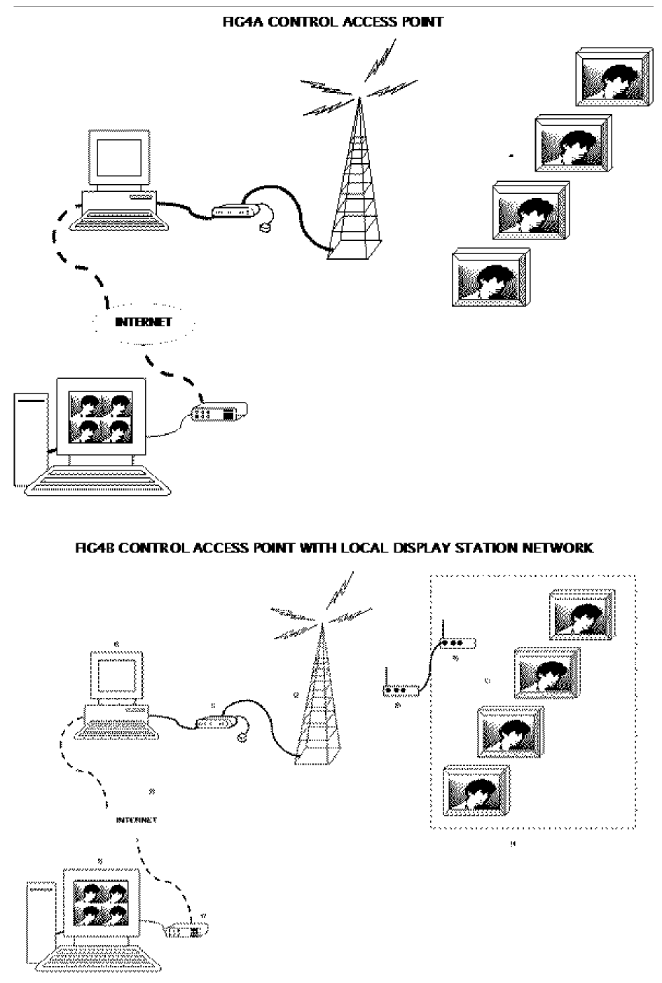

This arrangement of the control center accessing a wireless or wired network allows for the placement of the control center to be anywhere in the world where there is access to the internet. In this situation it is an embodiment of this invention to impose a control access point (CAP) in the system. The CAP is a gateway computer (19) that bridges (11) between the Internet (18) and the network connection (12) to the network of display stations (13), FIG. 4A. With this bridge in place, control personnel can be stationed anywhere in the world as long as they have access to a sufficiently fast connection to an internet server, the appropriate access codes to access the display station network, and the appropriate monitoring software. This allows the operator to provide backup control and maintenance services more cheaply and to provide “round-the-clock” monitoring from a convenient time zone, which also helps to control costs.

The same approach (FIG. 4B) is used for a display network for which signals cannot reach inside to the display stations. The same network structure with an outside AP (15) is accessed from a control computer (10) via an internet connection using the bridging computer (19) as a gateway to the display station network (13).

Theoretically, it is possible for a very remote computer, such as that depicted in FIGS. 4A and 4B, which is outside of the WAN, to contact the display stations without the use of the internet. However, this would require, for example, dialing in directly to the network server. If this computer is located in an overseas location, it would be very expensive to access the display stations for long periods of time in this manner. The capability of this invention to use the services of the internet to locate control computers in lower cost areas, provides an additional cost efficiency.

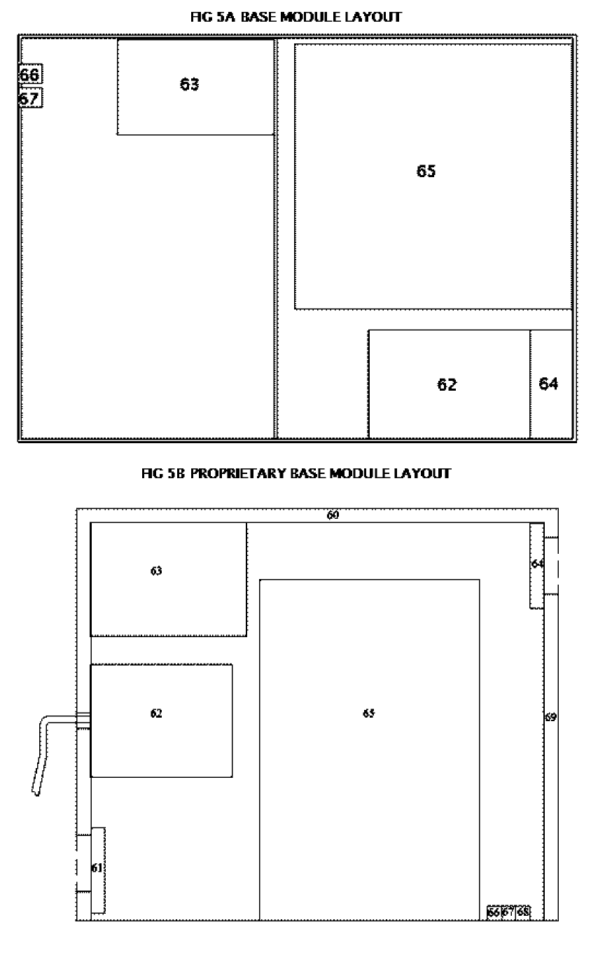

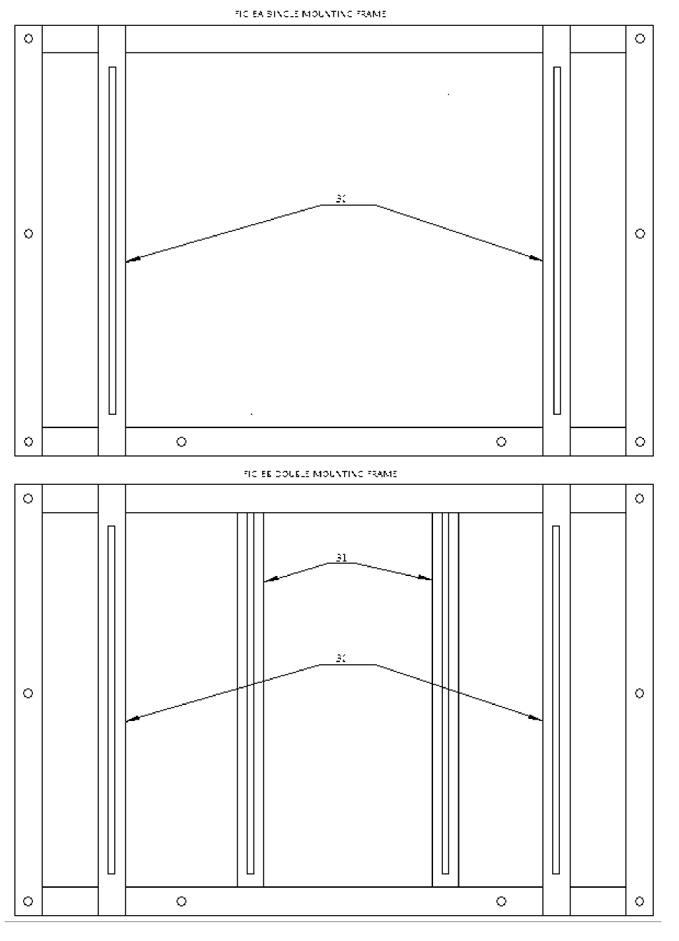

The display station is the hardware device that actually displays the information that will be viewed by the public. In its basic configuration, it consists of a computer module, speakers, a video camera, display screen, outer housing, and a protective transparent cover. There are many combinations of these components that are part of this invention. The basis for this flexibility is the modularity of the computer section, FIG. 5A and 5B.

The computer module, FIG. 5B, consists of the module casing (60), housing fans (61, 64), power supply (62), data storage device (63), motherboard (65), data ports (66-68), and cable port (69). The actual arrangement of the components within the module is not critical. The critical concept is to group the components within the module, and to maintain accessibility to the ports (66-68).

The modularity of the basic computer system that drives the display station provides for efficiencies in manufacturing and maintenance of the display stations. The basic arrangements of the components are the same in each device whether the display screen is one screen, a multiplicity of screens, a small screen or a large screen. The size of the screen and arrangement of screens can be changed but the basic computer module is the same.

There are several embodiments of the computer module that are within the scope of this invention. The preferred embodiments use a 1U, or 2U server housing or proprietary housing of smaller lateral size and approximately the same thickness, but with an open top and backplane to permit easier access to the modules internal components. In all three cases, the computer module is mounted on rails in the preferred embodiment to permit faster installation and maintenance. The rails on which the computer module is mounted are contained on the mounting frame, FIG. 6A. In another embodiment, the mounting frame, FIG. 6B, can contain two sets of rails, one for the computer module (30) and an additional set for the screen (31) depending upon whether the display station contains one display screen or a multiplicity of screens and, in the latter instance, the orientation of the screens

A mounting frame with two sets of rails, FIG. 6B, is used to mount a computer module (30) on one side of the frame and a display screen on the other side of the mounting frame (31). An inner set of rails is used for the display screen and an outer set oriented in the opposite direction for the module when the screen is smaller (less than approximately 32 inches diagonally) than the computer module. For lager screens, the mounting frame is larger and the inner rails are used for the computer module and the outer rails are used for the screen.

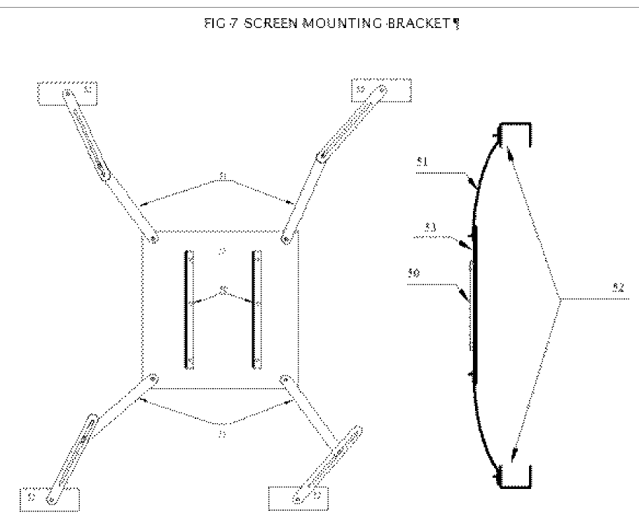

In order to mount a display screen on the rails, a proprietary clamping bracket, FIG. 7, is attached to the screen. The guides on the clamping bracket are then inserted into the rails on the mounting frame an the display screen is then pushed into its locked position.
The clamping bracket, FIG. 7, consists of a central hub (53) from which project four adjustable arms (51). At the end of each arm is an adjustable claw (52) which grasps the outer edge of a display screen. The claw is then tightened upon the display screen and the set screws on the adjustable arms are tightened to fix the clamping bracket to the back of the display screen. The hub end of the arms are attached to the hub by universal mounts so that the arm can be fixed at an angle from the hub to fit around the rounded housings of some displays and also fit to displays with flat backs. The rail guides (50) can then be inserted in the rails (31) of the mounting frame, FIG. 6B.

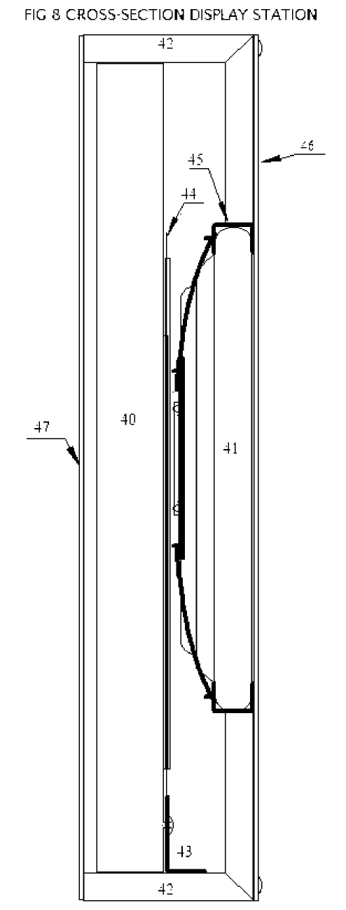

FIG. 8 shows a cross-section of the screen (41) and computer (40) module in a single screen housing (42). The mounting bracket (45) is clamped on the screen and attached to the mounting frame (44) by the guide rails. The mounting bracket is held in place by the support braces (43). The screen (41) is protected by the transparent shatter-proof plastic cover (46). The back cover (47) provides additional protection for the computer module and other internals.

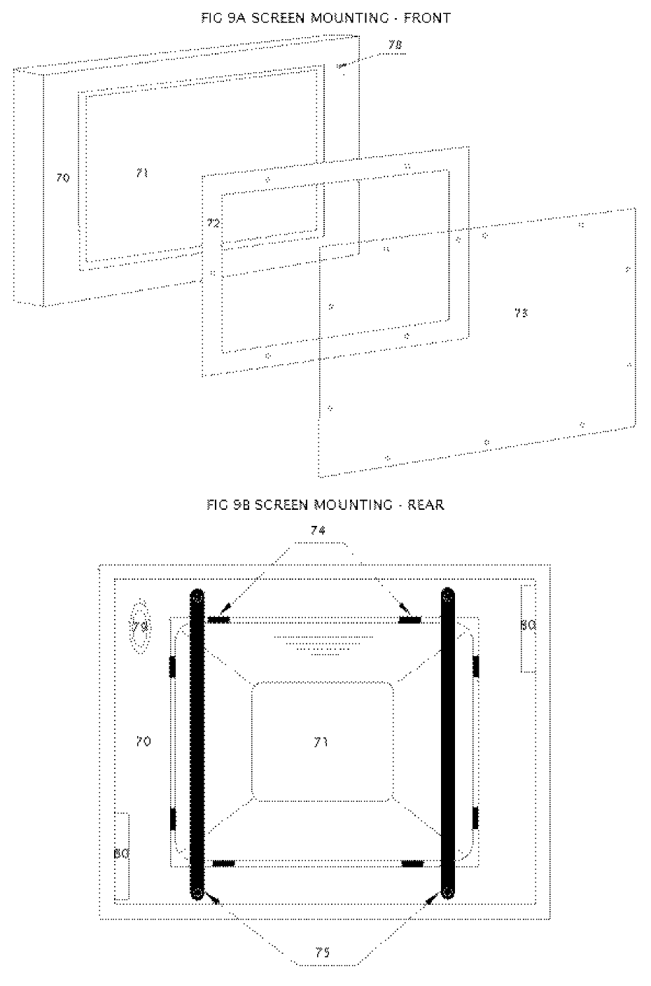

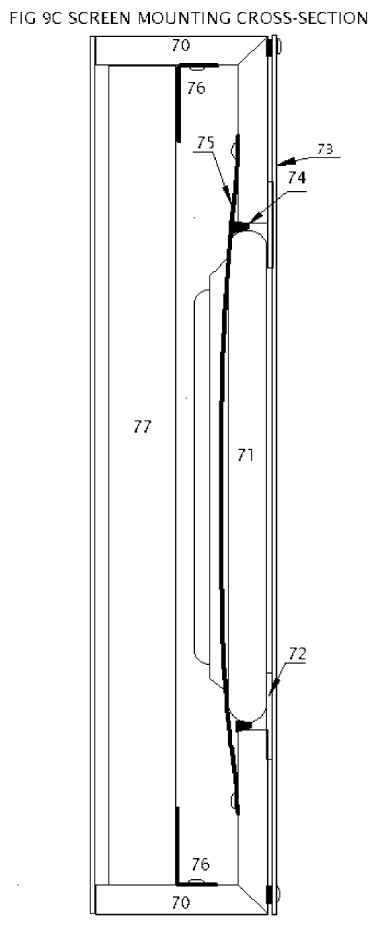

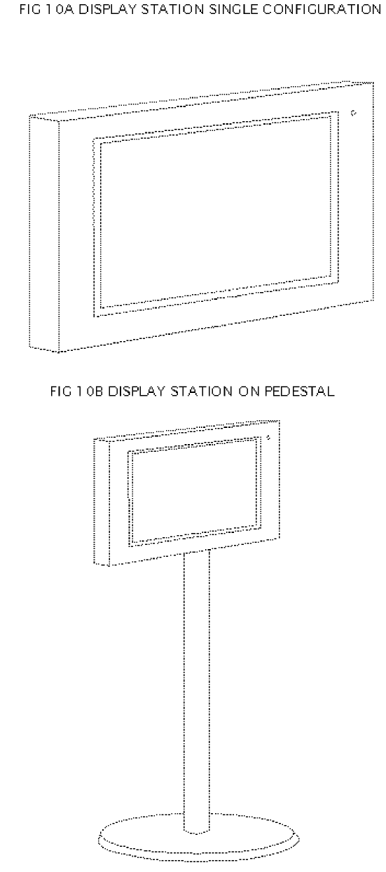

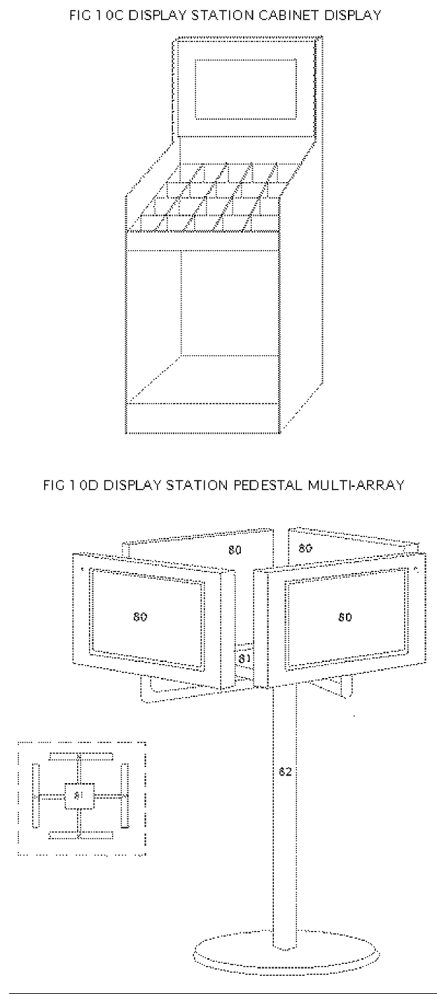

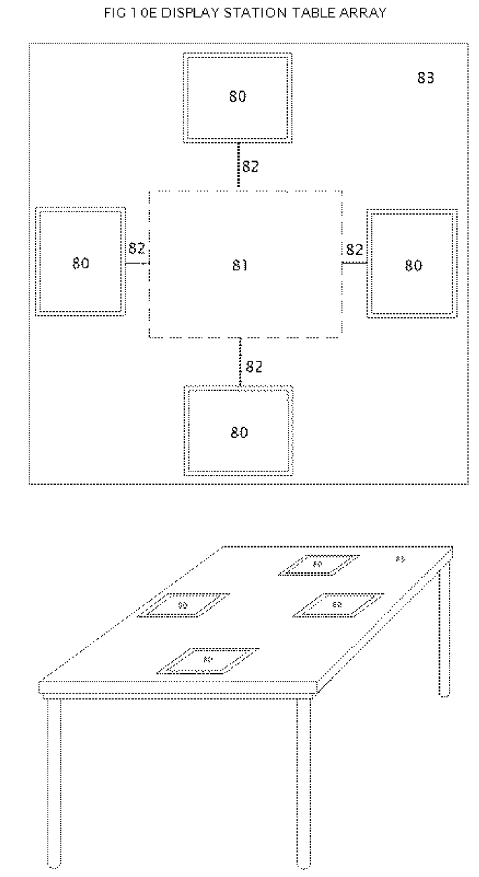

In the preferred embodiment, shown in FIG. 9A through C, the screen (71) is held in place in the display housing (70) by a retaining plate (72) in front of the screen. As in all embodiments, the front of the housing is covered by a rigid unbreakable protective transparent plastic sheet (73) to protect the screen. An opening (78) in the housing is provided for the camera lens which is also protected by the transparent plastic sheet (73).

The screen (71) is placed against the retaining plate (72) and, and friction spacers (74) are placed around the screen to fix it in place. Flexible metal straps (75) secure the screen in place. The computer module (77) is placed behind the screen supported by the L-braces (76). The camera (79) used to determine viewer statistics is typically located near the top of the unit, but its location can vary in the housing depending upon the needs of the location. The housing fans (80) provide ventilation inside the housing to keep the components cool.

The display station can have many display screen configurations. A single screen configuration is typically mounted on a wall, on a stand or in a display case. In this configuration the computer module and the screen are contained within the same housing. FIG. 9C shows a cross-section of this configuration.

Images from the video camera are captured and or streamed using software such as, but not limited to, Pysoft Active Webcam™ or Pysoft Broadcaster™, or proprietary software using a Microsoft Windows XP™ operating system, or Image Caster using an Apple™ based operating system.

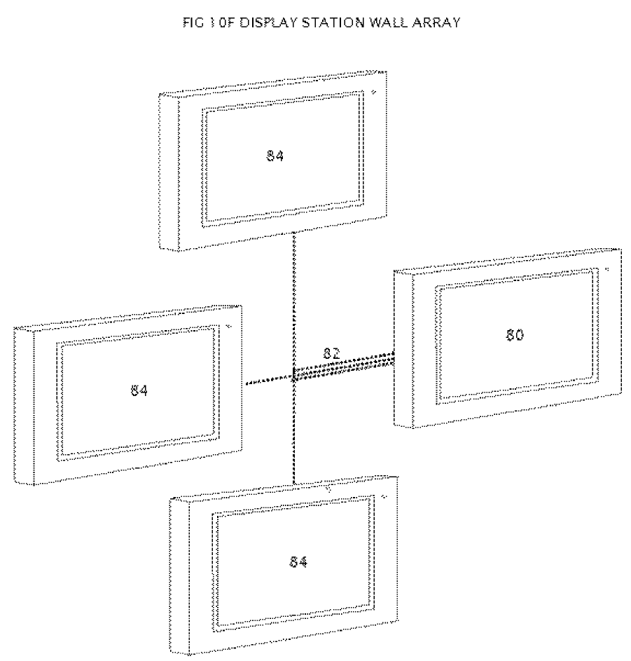

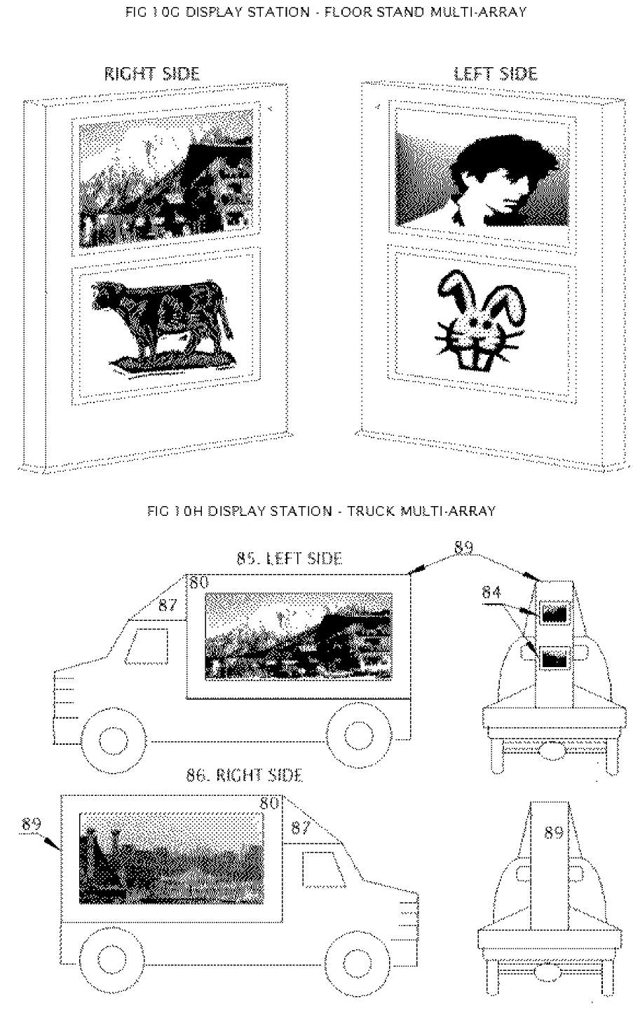

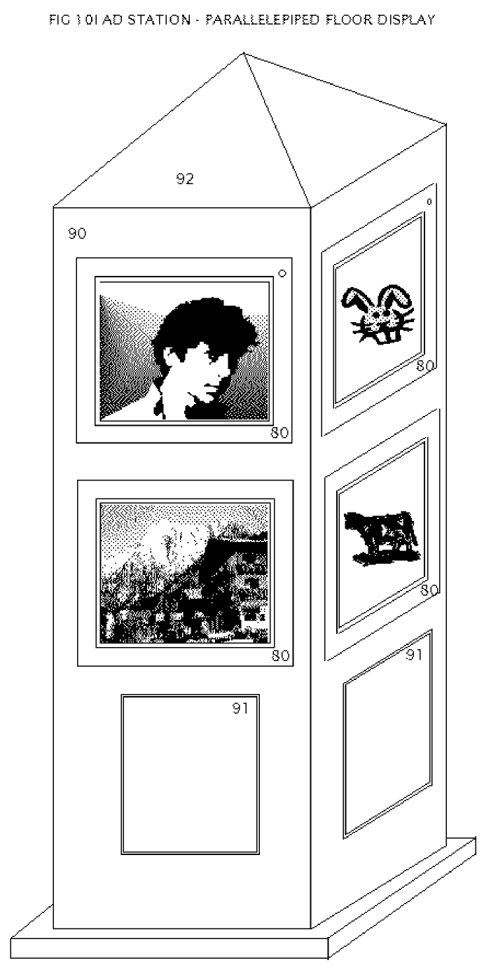

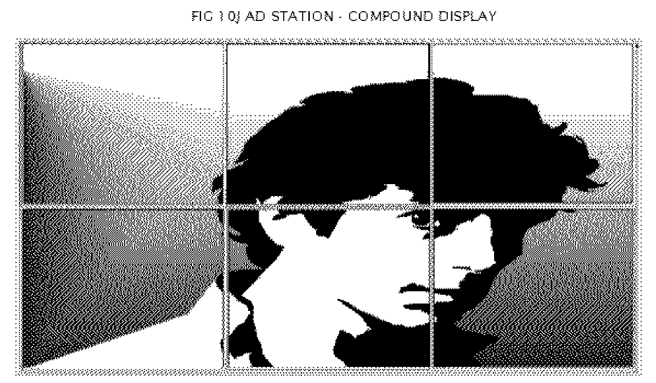

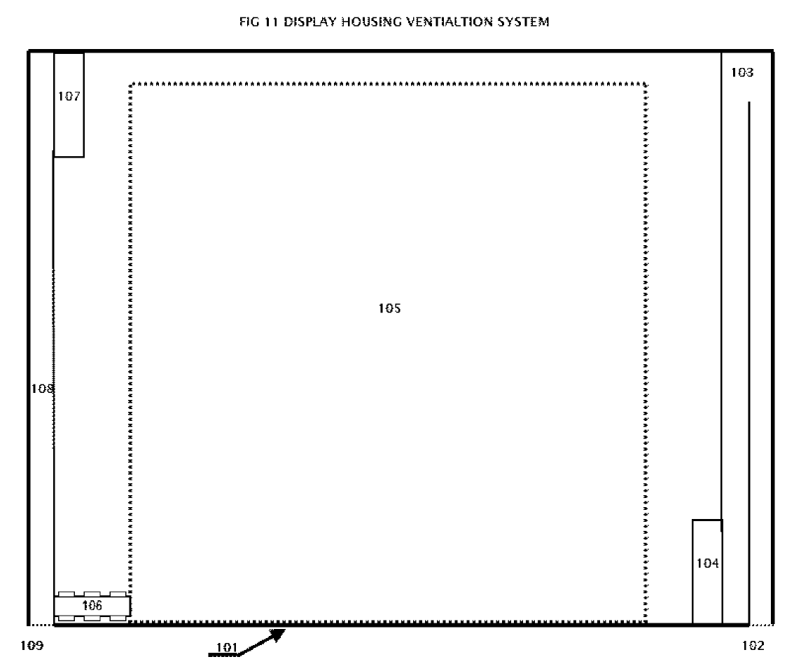

Typical configurations include, but are not limited to:
(1) FIG. 10A shows a single display screen with a computer module in the same housing hung on a wall.
(2) FIG. 10B portrays a single display station mounted on a pedestal.
(3) FIG. 10C depicts a computer module installed in a cabinet (88) with a display screen (80), the cabinet can have compartments to contain printed advertisement flyers (89), or the cabinet can contain dispensers such as a vending machine or the like.
(4) FIG. 10D shows a computer module in a central housing (81) connected to and controlling several display screens (80) surrounding the computer module mounted on a pedestal.
(5) FIG. 10E illustrates a computer module (81) mounted to the underside of a table (83) controlling (82) several display screens (80)—one at each seat location—facing up under a transparent table top, such that a person seated in that place would have an unobstructed view of the screen at that place.
(6) FIG. 10F shows a single computer module in the housing with one display screen (80) but controlling several connected (82) display screens (84) hung on a wall.
(7) FIG. 10G depicts multiple display screens in a single floor standing housing, each showing a different stream of information (as illustrated), or all showing the same information, or different information streams displayed on the upper and lower screens, but each side showing the same information.
(8) FIG. 10H shows a mobile display station, which consists of a large format display screen (80), LED or plasma, mounted on a flatbed truck; the computer module being contained in the housing (89) in which are mounted the display screens (80) which can show the same display on each side or different displays on the left screen (85) and the right side (86); the WAN access point or an antenna can be contained in an aerodynamic housing (87); the mobile display station can also have smaller display screens mounted on the back of the housing (89) (upper back view) or no screens (lower back view) the back screens can display the same information as shown on the left and/or right screens or a different information stream; the smaller back screens are viewable by traffic behind and near the mobile display. The angle of the screens can be varied from ninety to forty-five degrees relative to the back of the truck to provide optimal viewing. The top of the screens and the edges toward the front of the truck are protected by an aerodynamic housing to minimize drag and shear forces on the screen and truck. The configuration is shown with the screens mounted ninety degrees to the back edge of the truck.
(9) FIG. 10I depicts a parallelepiped floor mounted display station (90) containing four to eight display screens (80) driven by one computer module, which also contains space for static signs (91), the display screens can each display the same information stream or different information streams or a combination with the WAN access point in the decorative top.
(10) FIG. 10j shows one computer module mounted behind several contacting display screens each displaying part of the whole image; this configuration allows for a great deal of flexibility for the size of the display.
(11) FIG. 11 shows the baffle arrangement inside the outer housing (101) to provide ventilation for the electronic components in the housing. The intake (102) and exhaust (109) ventilation ports are both screened and located on the bottom of the housing to avoid the ingress of precipitation. The intake chamber (103) contains a baffle to further limit the intake of moisture. Air is drawn in via the intake fan (104) from the intake chamber (103). Air is exhausted by the exhaust fan (107) after passing over the computer module (105) and the display screen which is in front of it. Exhausted air is vented through the exhaust chamber (108) and port (109). The internal electrical outlet (106) allows connection of the screen and computer module power supplies to an external mains power supply and provides additional outlets to connect additional equipment for field service requirements.

Any of the fixed location configurations can be fitted with a thermal printer to print information regarding the information that is being displayed. A request is placed by the viewer by pressing a button and the information is printed and disseminated from the display station. They could also be fitted with a dispenser for preprinted information which a viewer could take as reinforcement for the messages given on the display.

It should be understood from the previous description that there are many additional arrangements of the relationship between the computer module and the display screen or screens.

The present invention may be embodied in other specific forms without departing from its essential characteristics. The described embodiments are to be considered in all respects only as illustrative and not restrictive. The scope of the invention is, therefore, indicated by the generality of the concept as it can be implemented by someone practiced in the art.

What is claimed is:

1. A self-contained relatively thin display system consisting of a flat display screen, a computer, a data storage device accessible by the computer, random access memory, a network interface, an audio output system, access ports to allow a keyboard and mouse to be connected to the device, and the necessary circuitry and operating system software which allows the parts to function together as a computer system. The display system being capable of receiving and storing electronic digital information in a format capable of being displayed on the attached screen. The system being of such an aspect ratio that it can be hung or mounted as would a static paper, cardboard or similar type of sign. The device being controlled locally by a computer internal to the device. The said computer equipped with the necessary software to display either static images, sequential images, or full motion video sequences. The information to be displayed is downloaded from one or more control and monitoring locations over a wireless or wired network and stored on the display device. The sequence of displaying the information is locally under the control of the display program, but can be changed remotely at any time by control personnel who monitor the display. The display system is contained within a protective case through which the display screen or screens are visible.

2. The display system of claim 1 equipped with multiple display screens so that the information being displayed can be seen from any horizontal direction, or with 2 displays, front and back, so that the information displayed can be seen on either side of the display, and in which any screen can be displaying the same or different information, and in which the display devices can be included in any configuration or furniture, such as a table, desk, cabinet or the like.

3. The display system of claim 1 in which multiple display screens are synchronized each screen displaying a part of a larger display in such a manner as to form a much larger single display.

4. The display system of claim 1 equipped with a camera to monitor the number of viewers of the display, allow for the determination of the demographics of the viewers of the display and as a security measure.

5. The display system of claim 1 wherein a plurality of display systems are connected via a wired or wireless secure network to a plurality of central control and monitoring centers; the network being accessible from any location at which general internet access is available.

6. The display system of claim 1 containing appropriate insulation and a heating and cooling system to allow the display device to be operated in essentially any environmental temperature range.

7. The display system of claim 1 wherein the display rendering, sequencing, monitoring and control is carried out using commercially available software.

8. The display system of claim 1 wherein the display rendering, sequencing, monitoring and control is carried out using proprietary software.

9. A display system which is flexible and can be arranged in any number of physical configurations to suite a particular location and to aid in the viewers′ accessibility to the device.

10. The display system of claim 1 wherein the device is equipped with means to allow a viewer to interact with the system and monitoring personnel; these means consisting of a VOIP telephonic device, a microphone and speaker system, or a touch-screen keypad.

11. A display system of claim 1 equipped with an internal printer which allows for the printing of coupons, brief informational items such as business cards, or directions and the like upon demand by a viewer.

12. A display system of claim 1 equipped with a universal clamping bracket to attach the display screen to a set of mounting rails.

13. A display system of claim 1 equipped with ventilation system which allows for the efficient circulation of air and prevents the intrusion of fluids.

14. A process for downloading, storing, displaying and modifying video and animated graphics remote from a plurality of display devices, and remotely monitoring and maintaining the display devices.

15. A process for monitoring the number and general demographics of the viewers in front of any display system at any time.

16. A mobile aerodynamic truck system allowing the use of the display system as a mobile billboard with display screens mounted at variable angles relative to the front or back edges of the truck bed.
